(19) United States
(12) Patent Application Publication
(10) Pub. No.: US 2009/0277062 A1
(43) Pub. Date: Nov. 12, 2009

(54) Set of Identification Plates

(76) Inventors: Klaus-Dieter Bier, Leutenbach (DE); Thomas Gangl, Mainhardt (DE)

Correspondence Address: COLLARD & ROE, P.C., 1077 NORTHERN BOULEVARD, ROSLYN, NY, 11576, US

(21) Appl. No.: 12/086,027

(22) PCT Filed: Nov. 15, 2006
(86) PCT No.: PCT/EP2006/010932

§ 371 Date: Jun. 4, 2008

(30) Foreign Application Priority Data
Dec. 6, 2005 (DE) 10 2005 058 387.3

(51) Int. Cl. G09F 3/18

(52) U.S. Cl. 40/642.02

(57) ABSTRACT

The invention relates to a set of identification plates (10) with inscribable identification plates (16) lying in a plane. According to the invention, a central carrier (12) is provided and has at least one elongated side carrier (14) integrally formed on it with one of its narrow sides respectively on two sides facing away from each other, wherein at least one of the side carriers (14) carries at least one identification plate (16) on at least one of its longitudinal sides.

The invention relates to a set of identification plates having inscribable identification plates that lie in a plane, in accordance with the preamble of claim 1, and to an arrangement of a plurality of sets of identification plates in accordance with the preamble of claim 10, respectively.

Such sets of identification plates, as they are known from DE 42 39 434 A1, for example, have a plurality of identification plates that are releasably attached to carriers, and form a span in a plane. The identification plates primarily serve to identify electrical components, for example to identify cables. The identification plates are combined into a set of identification plates, so that they can be better laid into an inscription device for inscribing. In the inscription device, all the identification plates of a set of identification plates can be inscribed in a single work step. Subsequently, the individual identification plates are taken out of the set of identification plates and used for identification. Furthermore, a strand is known from DE 42 39 434 A1, which consists of multiple sets of identification plates strung together, and is configured so that it can be rolled. The identification plates are affixed at crosspieces that extend between two longitudinal frame strips that run parallel. Each crosspiece carries identification plates only on one of its longitudinal sides. As a result, this structure is relatively complicated and the packing density of the identification plates is low. Furthermore, it is true that the strand can be configured as an endless strand that can be drawn into an inscription device by way of an intake device, for automatic inscription. However, for this purpose it has to be wound up onto a roll, and this takes up space.

It is therefore the task of the invention to further develop a set of identification plates and/or an arrangement of a plurality of sets of identification plates of the type stated initially, in such a manner that they are structured more simply, i.e. can be stored in space-saving manner.

This task is accomplished, according to the invention, by means of a set of identification plates having the characteristics of claim 1, and by an arrangement of a plurality of sets of identification plates having the characteristics of claim 10. Advantageous further developments of the invention are the object of the dependent claims.

The set of identification plates according to the invention, according to claim 1, is based on the idea that a simpler and less material-intensive structure is provided by forming the side carriers onto the central carrier, whereby at least one side carrier carries the identification plates on its longitudinal side or on both longitudinal sides. Furthermore, high packing density of the identification plates can be achieved by means of arranging the identification plates on both longitudinal sides of the side carriers.

The central carrier is preferably an elongated plate, whereby the side carriers are formed onto the longitudinal sides of the central carrier. It is practical if the set of identification plates then has a plane of symmetry that runs in the longitudinal direction of the central carrier. Then, the same number of identification plates is affixed on both sides of the central carrier, in the same geometrical arrangement. It is preferred that the central carrier has slanted or rounded corners, at least on one of its narrow sides. These serve as introduction bevels when the set of identification plates is drawn into an inscription device by machine. It is advantageous if the central carrier has a planar inscription surface for affixing an inscription. Furthermore, it is practical if the central carrier has at least one holder hole for setting it onto a holder mandrel. This facilitates automatically drawing the set of identification plates into an inscription device. There, the central carrier can be provided, on its inscription surface, with an inscription that characterizes the set of identification plates, which inscription is not supposed to appear on the identification plates.

It is preferred that the set of identification plates consists of one piece, preferably of plastic. In this way, it can be produced in particularly simple manner, using an injection-molding method or an extrusion method. Furthermore, it is also possible to produce the set of identification plates in one piece from metal, if necessary. In order to be better able to remove the individual identification plates, it is practical if planned breaking points are provided between them and the side carriers. Furthermore, planned breaking points can also be situated between the side carriers and the central carrier. This facilitates removal of the side carriers with the formed-on identification plates from the central carrier.

According to an advantageous embodiment, it is provided that the identification plates of each of the side carriers are disposed symmetrical to one another with reference to a plane of symmetry that extends in the longitudinal direction of the side carrier. This is particularly advantageous if the identification plates are used to identify cables that carry an identification plate at each of their ends. Then, it is advantageous if the identification plates disposed on a side carrier, opposite one another on the two longitudinal sides, are used to identify a cable.

It is advantageous if the side carriers have a continuation that does not carry an identification plate at their ends, in each instance. A hold-down of an inscription device can engage on this, to press the set of identification plates onto a support plane during an inscription process. It is practical if the continuation is thinner than the remaining part of the side carrier, in each instance.

The arrangement of identification plates according to the invention, according to claim 13, is based on the idea that the strand can be folded, according to the principle of an accordion fold, to save space, because the adjacent central carriers can be pivoted until they preferably lie flat on one another. In this connection, it can furthermore continue to be possible to roll the strand up onto a roll, if this is necessary. In both cases, the identification plates of the strand can be drawn into an inscription device using an automated method, and inscribed there. After inscription, the individual sets of identification plates are separated from one another. For this purpose, it is preferred that the central carriers are connected with one another in one piece. It is practical if the joints form planned breaking points for removing the sets of identification plates from the strand.

It is particularly preferred that the arrangement consists of sets of identification plates according to one of claims 1 to 12. If the central carrier of each set of identification plates is an elongated plate, it is preferred that the central carriers are connected with one another at their narrow sides.

It is practical if the arrangement of identification plates is produced in one piece, for example as an injection-molded part, as an extruded plastic part, as a part punched from a sheet, or as a plastic part with an injected film at the back. To implement the accordion-fold principle, it is sufficient if the central carriers that follow one another in a strand can be alternately pivoted, relative to one another, in two opposite directions that stand perpendicular to the plane spanned by the identification plates. However, it is preferred that the central carriers can be pivoted, relative to one another, about each joint, in two opposite directions that stand perpendicular to the plane spanned by the identification plates.

It is advantageous if the identification plates are disposed on each longitudinal side of the side carriers, at a distance from one another that corresponds to at least their width, and the identification plates of two sets of identification plates that follow one another in the row engage into one another in zipper-like manner. In this way, a particularly high packing density with only small interstices between the identification plates is achieved. The identification plates of at least one of the sets of identification plates can extend, at least partially, so far in the longitudinal direction of the strand, that their ends lie next to the central carrier of the next set of identification plates following in the row. When the sets of identification plates are cut at the joints, by a cutting device, this device can then, at the same time, cut off the ends of the ends of the identification plates lying next to the central carrier of the following set of identification plates, if these have to be shortened. However, it is also possible that the identification plates of at least one of the sets of identification plates extend, at least partly, in the longitudinal direction of the row, maximally all the way to the beginning of the central carrier of the next set of identification plates following in the row. Here, removal of a set of identification plates by means of a cutting tool can take place, without the identification plates being shortened.

In the following, the invention will be explained in greater detail using exemplary embodiments shown in the drawing. This shows:

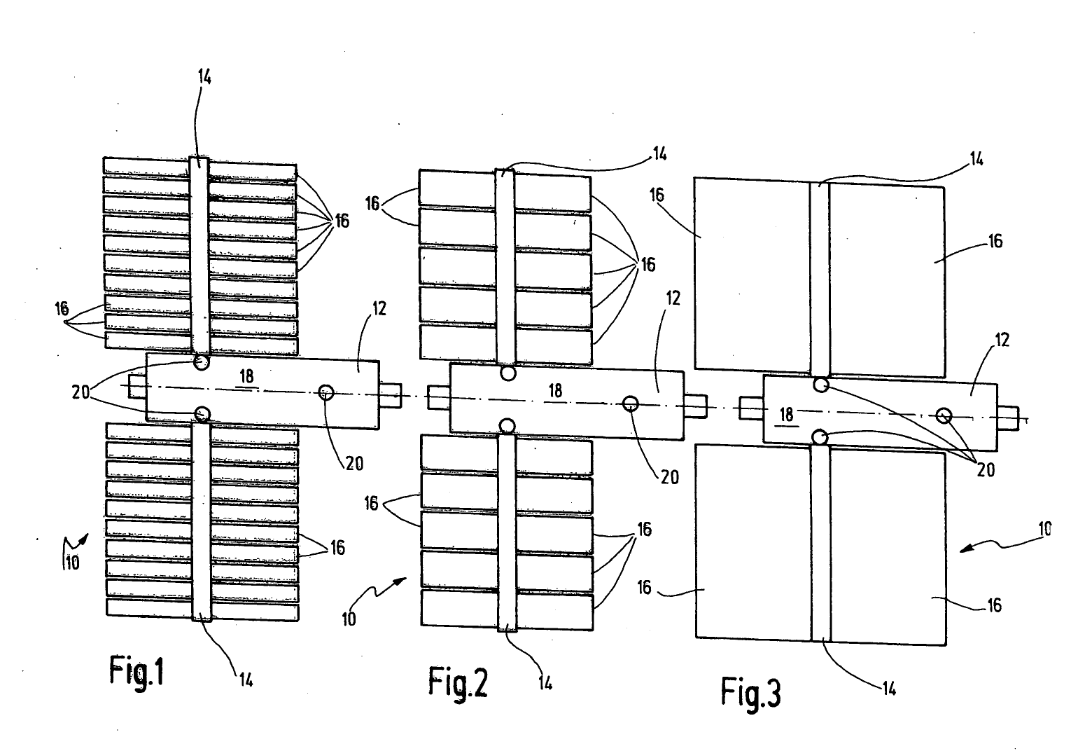

FIGS. 1 to 4 and 8 five exemplary embodiments of a set of identification plates in a top view, and

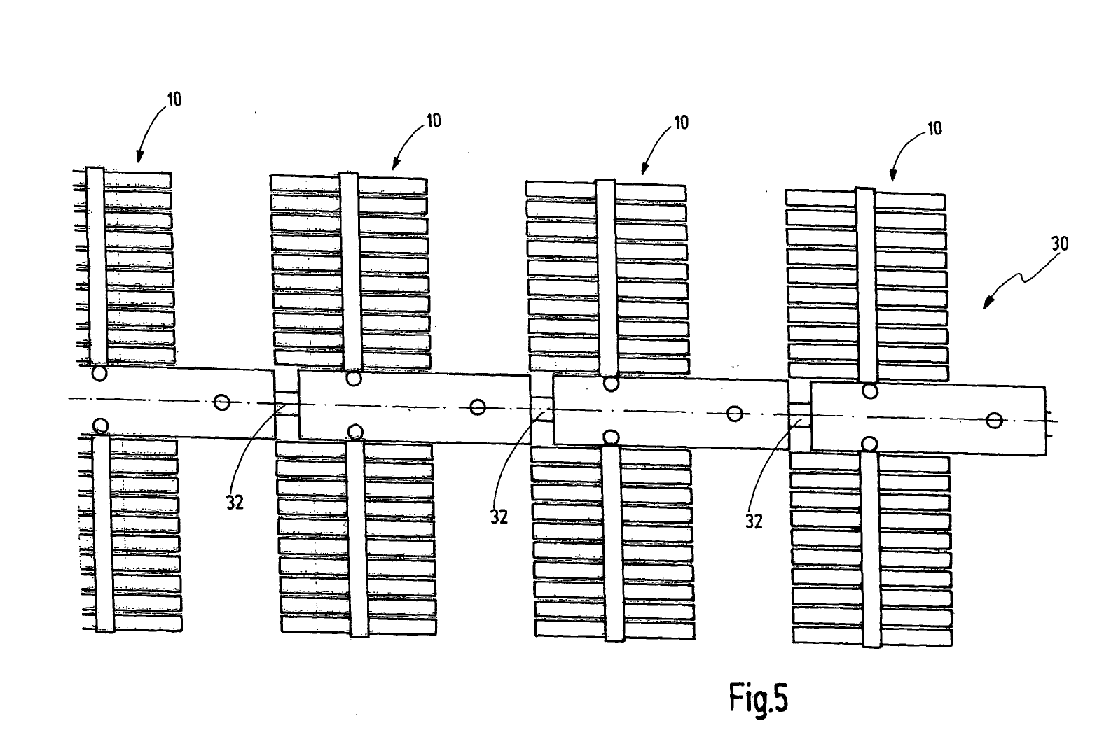

FIG. 5 to 7 three exemplary embodiments of an arrangement of sets of identification plates that form a strand.

A set 10 of identification plates according to FIGS. 1 to 4 has a central carrier 12 configured as an elongated plate, from the longitudinal sides of which plate, which face away from one another, a side carrier 14 extends, in each instance. In this connection, the longitudinal axis of each of the side carriers 14 runs perpendicular to the longitudinal axis of the central carrier 12. Identification plates 16 are formed onto the side carriers 14, on their longitudinal sides, which plates are connected with the side carriers 14 by way of a planned breaking point, in each instance. The identification plates 16 are spanned in a plane, so that they can be jointly inscribed in an inscription device. Their inscription surfaces, which are shown in the top views according to FIG. 1 to 4, lie in a plane with an inscription surface 18 of the central carrier 12. In all four exemplary embodiments, the set 10 of identification plates, in each instance, is symmetrical with reference to a plane of symmetry that runs through the longitudinal axis of the central carrier, perpendicular to the inscription surface 18. In the case of the first three exemplary embodiments according to FIG. 1 to 3, the identification plates 16 are also disposed symmetrical with reference to another plane of symmetry, which runs through the longitudinal axis of the side carriers 14, perpendicular to the plane spanned by the identification plates 16. The sets 10 of identification plates of the first three exemplary embodiments differ from one another merely in the number and size of the identification plates.

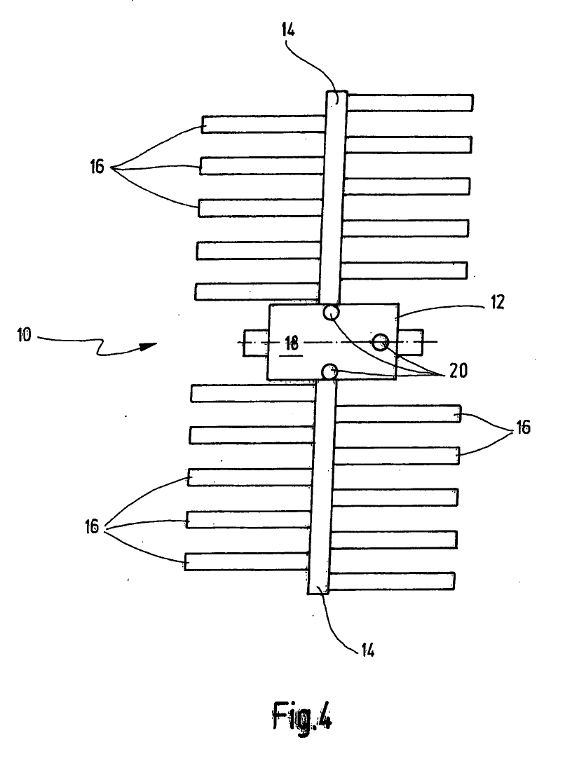

The identification plates 16 of the set 10 of identification plates according to FIG. 4 are not disposed symmetrically with reference to the plane that runs along the side carriers 14. Five identification plates 16 are formed onto each longitudinal side of the side carriers 14, and disposed relative to one another at a distance that is slightly greater than their width. On the opposite longitudinal side, five identification plates 16 are also formed on, at a distance from one another. These are situated at the level of a gap between the identification plates 16 of the other longitudinal side, in each instance.

Sets 10 of identification plates, as shown in FIGS. 1 to 4, can form a strand 30, as shown in FIG. 5 to 7. For this purpose, a plurality of sets 10 of identification plates is disposed in a row, so that the longitudinal axes of their central carriers 12 coincide. Two sets 10 of identification plates that follow one another in the row are connected with one another by way of a joint 32, in each instance, which allows pivoting of the sets 10 of identification plates relative to one another, until their central carriers 12 lie flat on one another. The joints 32 allow pivoting in both directions perpendicular to the plane spanned by the identification plates 16, in other words into the plane of the drawing and out of the plane of the drawing, in each instance, in FIGS. 5 to 7. In this way, the strand can be folded in an accordion fold. The entire strand is produced in one piece, as an injection-molded part or by means of extrusion. In this connection, the joints 32, which are structured to be thinner than the central carriers 12, serve as planned breaking points for removing individual sets 10 of identification plates from the strand 30.

In the case of the strand 30 according to FIG. 5, the identification plates 16 of the set 10 of identification plates that project to the left from the side carriers 14 only extend to the beginning of the central carrier 12 of the adjacent set of identification plates. In this way, it is possible to separate the individual sets of identification plates from one another in the region of the joint 32, by means of a cutting tool that is set on perpendicular to the longitudinal axis of the central carriers 12, without thereby also cutting off the ends of the identification plates 16.

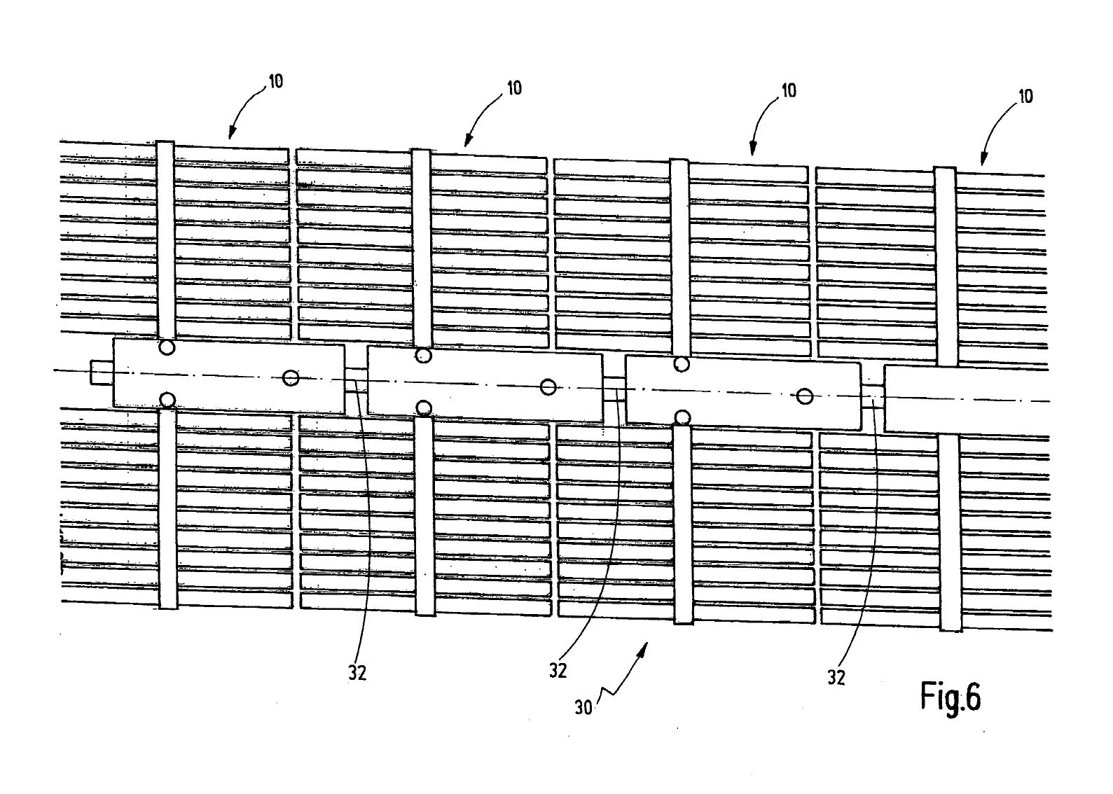

In this point, the strand 30 according to FIG. 6 differs. Its identification plates 16 of each set 10 of identification plates, which project to the left from the side carriers 14, extend so far in the longitudinal direction of the strand that their ends are situated next to the central carrier 12 of the adjacent set of identification plates. In this way, it is possible to shorten half of the identification plates 16 in one work step, by means of a cutting tool, when removing the sets 10 of identification plates.

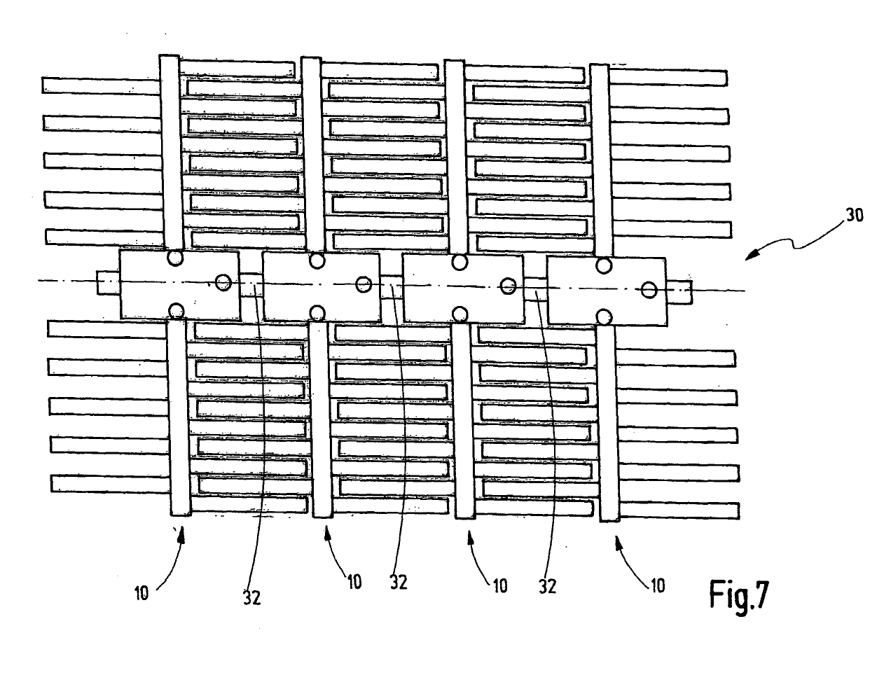

The strand 30 according to FIG. 7 is composed of sets of identification plates according to FIG. 4. Their central carriers 12 are shorter than the central carriers of the sets of identification plates according to FIGS. 1 to 3. In this way, the identification plates 16 of sets 10 of identification plates that follow one another in a row engage into one another in zipper-like manner, so that a high packing density of the identification plates 16 occurs.

In all the exemplary embodiments, the central carriers 12 are provided with holder holes 20, so that they can be set onto holder mandrels, which facilitates automatically drawing them into an inscription device, for example. For this purpose, a whole-number multiple of the distance between two holder holes 20 of sets 10 of identification plates that follow one another in a row corresponds to the distance between two consecutive holder mandrels of the inscription device.

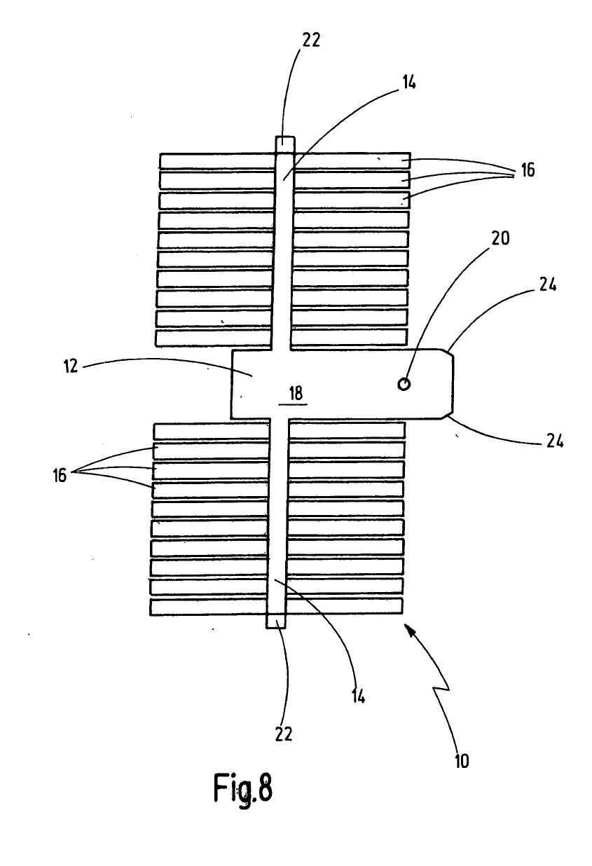

The set 10 of identification plates according to the fifth exemplary embodiment (FIG. 8) corresponds, in terms of its structure, essentially to that of the first exemplary embodiment (FIG. 1). Therefore, characteristics that correspond to one another are provided with the same reference symbols. The set 10 of identification plates according to FIG. 8 has a continuation 22, in each instance, at the ends of the side carriers 14, which does not carry an identification plate 16. The continuation 22 is thinner than the section of the side carrier 14 that carries the identification plates 16, and serves as an engagement point for a hold-down for pressing the set 10 of identification plates onto a support plane of an inscription device. Furthermore, the central carrier 12 has slanted corners 24 on one of its narrow sides, which form introduction bevels when the set 10 of identification plates is drawn into a guide rail of an inscription device, by means of a mechanical intake.

In summary, the following should be stated:

The invention relates to a set of identification plates having inscribable identification plates 16 that lie in a plane. According to the invention, a central carrier 12 is provided, onto which at least one elongated side carrier 14 is formed with one of its narrow sides, on two sides that face away from one another, in each instance, whereby at least one of the side carriers 14 carries at least one identification plate 16 on at least one of its longitudinal sides.

1. Set of identification plates having inscribable identification plates (16) that lie in a plane, wherein a central carrier (12), onto which at least one elongated side carrier (14) is formed with one of its narrow sides, on two sides that face away from one another, in each instance, whereby at least one of the side carriers (14) carries at least one identification plate (16) on at least one of its longitudinal sides.

2. Set of identification plates according to claim 1, wherein each of the side carriers (14) carries at least one identification plate (16) on its longitudinal sides, in each instance.

3. Set of identification plates according to claim 1, wherein the central carrier (12) is an elongated plate, and that the side carriers (14) are formed onto the longitudinal sides of the central carrier (12).

4. Set of identification plates according to claim 3, wherein it has a plane of symmetry that runs in the longitudinal direction of the central carrier (12).

5. Set of identification plates according to claim 3, wherein the central carrier (12) has slanted or rounded corners (24) at least on one of its narrow sides.

6. Set of identification plates according to claim 1, wherein the central carrier (12) has a planar inscription surface (18) for affixing an inscription.

7. Set of identification plates according to claim 1, wherein the central carrier (12) has at least one holder hole (20) for being set onto a holder mandrel.

8. Set of identification plates according to claim 1, wherein it consists of one piece, preferably made of plastic.

9. Set of identification plates according to claim 1, wherein planned breaking points between the identification plates (16) and the side carriers (14) and/or between the side carriers (14) and the central carrier (12).

10. Set of identification plates according to claim 1, wherein the identification plates (16) of each of the side carriers (14) are disposed symmetrical to one another with reference to a plane of symmetry that extends in the longitudinal direction of the side carrier (14).

11. Set of identification plates according to claim 1, wherein the side carriers (14) have a continuation (22) that does not carry an identification plate, at their ends, in each instance.

12. Set of identification plates according to claim 11, wherein the continuations (22) are thinner than the sections of the side carriers (14) that carry the identification plates (16).

13. An arrangement of a plurality of sets (10) of identification plates having inscribable identification plates (16) that lie in a plane, forming a strand, wherein each set (10) of identification plates has a central carrier (12) made of flat material, which carries the identification plates (16) on two sides that face away from one another, and that the central carriers (12) are disposed in a row and connected with one another by means of joints (32), so that they can be pivoted relative to one another until they come to lie on one another.

14. Arrangement according to claim 13, wherein the central carriers (12) are connected with one another in one piece.

15. Arrangement according to claim 13, wherein the joints (32) form planned breaking points for removing individual sets (10) of identification plates.

16. Arrangement according to claim 14, wherein it is an injection-molded part, an extruded part, a part punched from a sheet, or a plastic part with an injected film at the back.

17. Arrangement according to claim 13, wherein the central carriers (12) can be pivoted, relative to one another, about each joint (32), in two opposite directions that stand perpendicular to the plane spanned by the identification plates (16).

18. Arrangement according to claim 13, wherein the central carriers (12) that follow one another in a row can alternately be pivoted, relative to one another, in two opposite directions that stand perpendicular to the plane spanned by the identification plates (16).

19. Arrangement according to claim 13, wherein it consists of sets (10) of identification plates according to one of claims 1 to 12.

20. Arrangement according to claim 19, wherein the identification plates (16) are disposed on each longitudinal side of the side carriers (14), at a distance from one another that corresponds at least to their width, and that the identification plates (16) of two sets (10) of identification plates that follow one another in the row engage into one another in zipper-like manner.

21. Arrangement according to claim 19, wherein the identification plates (16) of at least one of the sets (10) of identification plates extend, at least partly, so far in the longitudinal direction of the strand (30) that their ends lie next to the central carrier (12) of the next set (10) of identification plates that follows in the row.

22. Arrangement according to claim 19, wherein the identification plates (16) of at least one of the sets (10) of identification plates extend, at least partly, in the longitudinal direction of the strand (30), maximally to the beginning of the central carrier (12) of the next set (10) of identification plates that follows in the row.
